(19) United States
(12) Patent Application Publication
(10) Pub. No.: US 2020/0207435 A1
(43) Pub. Date: Jul. 2, 2020

(54) BICYCLE WITH INTEGRATED ELECTRONIC COMPONENTS

(71) Applicant: Volata Cycles, Inc., San Francisco, CA (US)

(72) Inventors: Marco Salvioli Mariani, Milan (IT); Mattia De Santis, Milano (IT); Fabrizio Martini, Boston, MA (US)

(21) Appl. No.: 15/752,213

(22) PCT Filed: Aug. 15, 2016
(86) PCT No.: PCT/US2016/047057

§ 371 Date: Feb. 12, 2018

Related U.S. Application Data
(60) Provisional application No. 62/205,143, filed on Aug. 14, 2015.
(60) Provisional application No. 62/222,331, filed on Sep. 23, 2015.

(51) Int. Cl. B62J 50/22; B62J 6/03; B62J 6/04; B62J 45/20; B62J 50/21; B62J 6/12; B62J 45/414; B62J 3/12; G06F 3/033

(52) U.S. Cl. CPC B62J 50/22; B62J 6/03; B62J 6/04; B62J 45/20; B62K 19/40; B62J 6/12; B62J 45/414; B62J 3/12; G06F 3/033; B62J 50/225

(57) ABSTRACT

A smart bicycle includes various integrated electrical accessories. The bicycle frame has an integrated computer processor, a global positioning system (GPS) receiver, horn and rear light. The stem of the bicycle has an integrated visual display that provides performance and directional information to the user. The fork of the bicycle has integrated lights and the front wheel can have an integrated dynamo generator that can power the electrical components and charge a system battery. The ride data can be transmitted to a smartphone and/or system servers, which can also store, analyze and display the rider data.

### CROSS REFERENCE TO RELATED APPLICATIONS

This patent application claims priority to U.S. Provisional Patent Application No. 62/205,143, “High-Tech Smart Bicycle Including Advanced Features And Integrated Accessories,” filed Aug. 14, 2015 and U.S. Provisional Patent Application No. 62/222,331, “High-Tech Smart Bicycle Including Advanced Features And Integrated Accessories,” filed Sep. 23, 2015, which are hereby incorporated by reference in their entirety.

### FIELD OF INVENTION

The present invention relates to bicycles with integrated electrical components including: lights, horns and computers.

### BACKGROUND

Bicyclists tend to purchase a bicycle and accessories, which are attached to the bicycle. These accessories can include lights, bicycle computers, and bells. Bicycle riders like to view riding metrics and information (e.g. speed, riding time, burned calories, etc.). Bicyclists can purchase computers with a visual display coupled to a special handlebar mounting system. However, their batteries need to be charged often and the computers can be lost or get stolen.

Cyclists can also purchase lighting systems. Biking without a proper lighting system at night is dangerous. The cyclists risk of not being seen by cars, and they risk of not seeing obstacles of various nature especially in the urban context. Existing front lighting systems can consist of lights with a special handlebar mounting system. Rear light systems are normally mounted on the seat post, seat, or frame of the bike pointing backwards. The batteries used to power the lighting systems need to be charged often and they can also be easily removed from the bicycle, which can result in the battery being lost or stolen. Also, the light beam can be pointing to the road with the wrong angle. Biking around without a proper lighting system is dangerous both for the risk of not being seen by cars, and for the risk of not seeing road obstacles especially in the urban context.

Urban biking or biking in general without a proper horn or an audio output device that is able to emit alerting sounds can be dangerous. Car drivers can sometimes open car doors without checking rear view mirrors and pedestrians cross the street without properly checking, etc. There are many dangers that can be avoided with a proper horn system for the bicycle. Bicyclists can purchase bells or horns with a special handlebar mounting system.

### SUMMARY OF THE INVENTION

The present invention is directed towards a smart bicycle that can include various integrated electrical accessories. The stem of the bicycle can include a computer processor, a global positioning system (GPS) receiver and a visual display. The GPS receiver can receive location information from GPS satellites, which is transmitted to the processor, which can be used to track the rider's metrics, which can then be viewed on the display. In an embodiment, the rider's metrics can also be transmitted to a smartphone, which can also store, analyze and display the rider metric data. The bicycle with integrated components can also include embedded smart lights and a horn. The electrical components can be coupled to a rechargeable battery and an electrical generator, which is powered by a rotating wheel of the bicycle.

The invention disclosed herein refers to an innovative way to think and approach to a brand new smart usage of the greenest method of modern urban transportation: the bicycle. The main concept behind this invention is to have a bicycle with all the high-demanded accessories requested by everyday users already integrated in the bicycle itself. No extra accessories will be required to enjoy a full and safe drive experience around the city and/or outside the city and/or between cities.

The herein disclosed technology related to the built-in display in a bicycle stem that includes an internal volume which can contain a processor and an integrated display. The display can be in various sizes. For example, the display may typically range from 1 to 3 inches, but in other embodiments the display can be any size. The display electronics can also be based on various different technologies such as: OLED, LCD, LCD TFT, GRAPHIC LCS, etc. The display unit of the present invention can have various advantages. The bicycle has a display that is integrated in construction with the stem of the bicycle and cannot be easily taken apart from the stem. An internal battery does not need to be charged prior to riding the bicycle because there is no risk that the display battery will be fully discharged, leaving the rider without a functional display. The system can be powered by a central battery unit that may constantly be charged by the front dynamo hub when the bicycle is moving. The display is embedded in the handlebar clamp that fastens the handlebar to the stem, with screws or bolts. If the display malfunctions or needs to be replaced, the handlebar clamp can be easily removed without replacing the entire stem. However, the handlebar clamp cannot be disassembled easily and fast enough to be stolen by thieves. In some embodiments, the screws or bolts used to secure the handlebar clamp to the stem may have a special driving interface that may require a special tool to remove the screws and bolts. The display is easy to see and is located in the center of the handlebar. The stem and frame of the bicycle can have internal passageways, which allow the electrical cables to be hidden within the stem and frame. Thus, no cables are exposed to the environment since they are routed inside the stem to the frame of the bicycle. The display is connected to the central electronics control unit of the bike. The display can show any data that the firmware and processors transmit to the display. This ability makes the display multifunctional and adaptable to any desired display output. The display does not require any add-on accessories, which are designed to only perform one task. The display can be totally integrated with the rest of the bike electronics systems.

The inventive bicycle includes technology that is related to an integrated smart front light system that can include multiple front lights embedded in the bicycle front fork. For example, one light can be mounted in each of the left and right for fork legs. This lighted fork leg configuration has several advantages. The bicycle comes with a native lighting system that cannot be easily taken apart from it; this reduces the risk of not having a working lighting system on the bike. No battery needs to be charged for the electrical systems to be functional whenever the bicycle is ridden. Thus, there is no risk that the light battery fully discharges thereby leaving the rider with no light. A central battery unit that powers the lights is constantly charged by the front dynamo hub when the bicycle is rolling and powers the electrical systems.

In an embodiment, the inventive bicycle includes two lights mounted on the two fork legs of the fork. These multiple lights improve the case of malfunctioning or failure of a single LED unit, one of the two LEDs on either the left or the right fork leg can still work. In the case of a single LED unit (like most of the add-on lights for bicycles mounted on the handlebar) this single light failure would result in the total absence of light emission of the bike. In an embodiment, the lights can be mounted on the fork so there is no need of a custom designed handlebar that has embedded lights or lights attached to a mounting bracket. With the lights on the fork some of the light will contact the rotating front wheel and reflect outward. This configuration can make the bike more visible from the sides. The lighting system can include a light sensor and the system can be configured to automatically turn the front and rear lights on, reducing the risk of forgetting to turn on the lights.

The rear lighting system can include various features. For example, the rear lighting system cannot be easily taken apart which reduces the risk of not having a working lighting system on the bike. The battery does not need to be charged because it is charged by the front dynamo hub power coupled to a wheel that provides power when the bicycle is rolling. Thus, there is no risk that the light battery will fully discharge and leave the rider with no light. The lights make the bike more visible from the side. In an embodiment, the lighting system can include a light sensor that automatically turn on the lights when there is little ambient light which reduces the risk of forgetting to turn on the lights.

The electronics system can include a structure that embeds the electronic components mentioned above, and the rear light. This makes possible to extract a compact structure with the bicycle electronics and the rear lights. The entire system is hidden into the bicycle frame's top tube and cannot be easily removed to steal components. On the other hand, the user or a mechanic with the right tools can take the electronic components apart from the bicycle for maintenance or repairing. Also, having the electronic components sealed inside the bicycle frame or components protects against exposure to water, dirt and other contaminants.

The herein disclosed technology related to the horn system invention consists in a particular convenient way to locate horn, USB plug, light sensor, and temperature sensor (or any combination of them) in a unique structure which is mounted on the head tube of a bicycle. The bicycle can have an integrative native horn that cannot be easily taken apart or removed from the bicycle. This integration reduces the risk of not having a working horn system on the bike. As discussed, the battery is charged when the bicycle rolls so there is no risk that the light battery will be fully discharged, leaving the rider with no horn. The horn system can be powered by the bicycle's central battery unit which is constantly charged by the front dynamo hub.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a side view of an embodiment of a bicycle frame;

FIGS. 2 and 3 illustrate embodiments of block diagrams of the electronic system components;

FIG. 4 illustrates a top perspective view of an embodiment of a stem and handlebar;

FIG. 5 illustrates a top perspective exploded view of an embodiment of a handlebar clamp;

FIG. 6 illustrates an embodiment of an embedded LED light system on the front fork;

FIG. 7 illustrates an embodiment of an exploded view of an embodiment of a front fork light;

FIG. 8 illustrates an embodiment of a front portion of a bicycle illuminating the ground and objects with a front fork light;

FIG. 9 illustrates an exploded view of an embodiment of rear light system;

FIG. 10 illustrates an exploded view of a front horn assembly;

FIG. 12 illustrates a top view of an embodiment of a joystick and display;

FIG. 13 illustrates a flow chart of the antitheft mode operation;

FIGS. 14-24 illustrate different user interface apps on visual displays.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

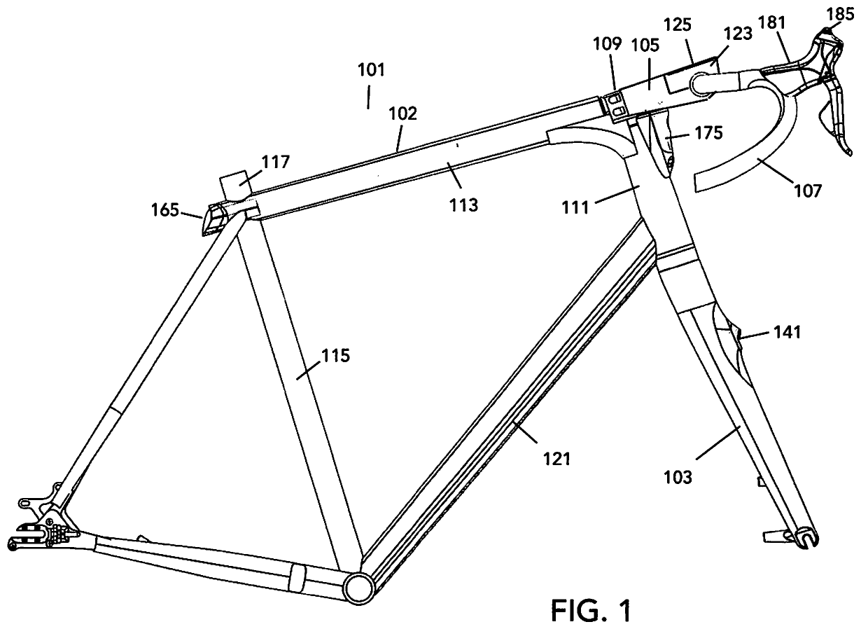

The inventive bicycle can include a computer processor and an integrated visual display output that is built into a stem of the bicycle. FIG. 1 illustrates an embodiment of a bicycle 101 that includes a frame 102 that includes a top tube 113, a head tube 111, a lower seat tube 115 and upper seat tube 117. The fork 103 can be coupled to the bottom of a steer tube 109 that rotates within the head tube 111. The top of the steer tube 109 can be coupled to a rear portion of a stem 105 and the front portion of the stem 105 is coupled to the handlebar 107 with a handlebar clamp 123. The handlebar clamp 123 can also include an integrated visual display 125. In different embodiments, various different electrical components can be integrated with the bike frame 102 and fork 103.

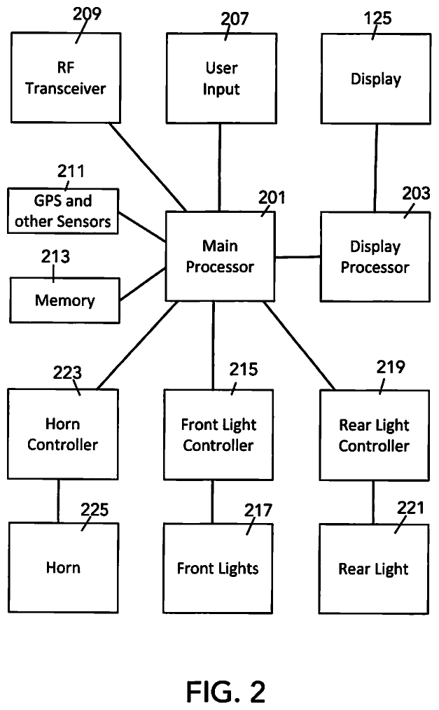

System electronics. The inventive bicycle includes various electrical systems which can be controlled by a user interface. The different system components can be mounted in various different locations of the bicycle. With reference to FIG. 2, the inventive system can include: a main processor 201 and a display processor 203 which communicate with each other. The main processor 201 manages various electronic features and in some embodiments the bike can be connected to one or more RF transceivers 209 which can include long range general packet radio service (GPRS) which can allow for cell phone communications and short range radio frequency (RF) communications to local devices such as a smartphone via Bluetooth. The system can also include a global positioning system (GPS) and sensors input 211 which can provide position information to the main processor 201. The processor 201 can use the GPS input 211 information to calculate: speed, distance, location, direction, position, accent/descent angles and other information. In some embodiments, the system can also utilize data from other sensors. For example, the speed of the bicycle can be determined by the processor by a signal from a magnetic transducer sensor that detects a magnet coupled to a portion or a rotating wheel. In another embodiment, a dynamo hub can also emit a rotational speed signal that can be used by the processor to determine the bicycle speed which can be transmitted to the display 125 so this information can be seen by the bicycle rider.

The display processor 203 is coupled to and controls a visual display 125. The visual display 125 can be a graphical screen that can operate based on various possible different technologies such as: OLED, LCD, LCD TFT, GRAPHIC LCS, etc. In some embodiments, the visual display 125 may be a touch sensitive device, which can receive user touch screen inputs, which can be transmitted to the main processor 201. In other embodiments, the system can have a separate user input 207. For example, the user input 207 can be an electrical button, switch, or even a joystick as disclosed in U.S. Provisional Patent Application No. 62/222,331. The user can manipulate the position of the joystick, which can allow a visual indicator to move on the display 125. The system may be configured to indicate the position of the joystick on the display 125. For example, the display may show a plurality of display options and the joystick can be used to move an indicator to a desired option. When the joystick is moved to the desired option, the user can then depress the joystick straight down to select the indicated control on the display 125.

The system can be used to control a horn 225, a rear light 221 and front lights 217. The system may receive a user input 207 which can be a button on a left brake lever hood. The horn input signal can be transmitted to the main processor 201 which can instruct the horn controller 223 to actuate the horn 225 which can be an electric buzzer such as a piezoelectric buzzer, speaker or any other electrical sound emitter. In an embodiment, the system may have controls, which can allow the user to alter the horn sound to a user desired sound pattern.

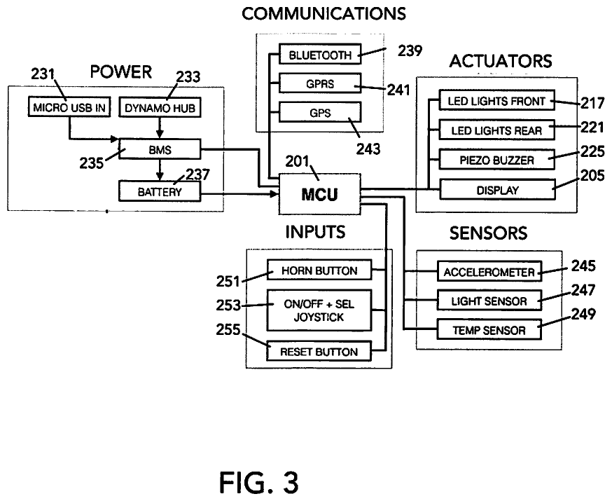

An embodiment of an electrical system that can be used with the bicycle is illustrated with reference to FIG. 3. The electrical system can include a battery 237 that is charged by a dynamo hub 233 which is coupled to a wheel. The dynamo hub 233 can generate electrical power when the wheel rotates around the dynamo hub 233 when the bike is ridden. Alternatively or in addition, the battery 237 can be charged by a power input 231 such as a micro USB input. Power from the power input 231 and dynamo hub 233 can be transmitted to a battery management system 235 that can control the charging of the battery 237. In an embodiment, electrical power can be directed from the battery 237 and/or the battery management system 235 to the main processor 201. In an embodiment, the battery management system 235 can be configured to charge a main battery which powers the system components: horn, lights and display from the dynamo hub and possibly a secondary battery that powers the drive train gearing system which allows the bicycle to always be able to shift gears.

The electrical system can include a plurality of actuators which can be controlled by the processor 201 and the user through input controls. The actuators can include LED front lights 217, LED rear lights 221, a horn 225 which can be a piezo electric buzzer, a display 205 which can be a visual display mounted in the stem of the bicycle. The user controls can include a horn button 251, an on/off switch, a joystick 253 and a reset button 255. The user can actuate the on/off switch 253 to turn the system on which can cause the main processor 201 to illuminate the display 205 so the user can interact with the user interface. The system may be in an off mode before being turned on which conserves electrical power. The user can then manipulate the joystick 253 to interact with the user interface. When the user presses the horn button 251, the main processor 201 can receive a horn signal from the horn button 251 and respond by transmitting a horn signal to the horn 225 which can emit a loud audio output to provide a warning to other people.

In some embodiments, the electrical system can communicate with other computing devices and receive information from other sources. For example, the main processor 201 may receive position information from a GPS receiver 243 which can be used by the processor to calculate speed, distance traveled, directions, etc. In some embodiments, the main processor 201 can communicate with a user's smart phone through a short range RF communications protocol such as Bluetooth transceiver 239. With this communications connection, information from the user's phone can be received by the Bluetooth transceiver 239 and displayed on the display 205. The main processor 201 can also communicate via cellular communications system with Internet based computer servers through a GPRS transceiver 241. For example, the main processor 201 can be configured to transmit ride data to a social network such as Strava', which can record and post the user's ride data automatically to the social network website.

In some embodiments, the system may include sensors such as an accelerometer 245, light sensor 247 and a temperature sensor 249. For example, the system can be configured to detect braking or crashes through the accelerometers 245. For example, a rapid deceleration signal detected by the accelerometers 245 (such as 5 m/s²) can be transmitted to the main processor 201 which can cause the rear light to be illuminated so that other cyclists will be warned. The accelerometers 245 can also be used to detect problems with the bicycle. For example, a rapid deceleration or acceleration (such as 20+m/s²) followed by a lack of movement can indicate a collision. The system can transmit a request for confirmation that the cyclist is OK to the display 205 and if a confirmation is not received within a few minutes, the system can transmit a notification through the cellular GPRS transceiver 241 to an emergency contact. In an embodiment, the light sensor 247 can detect the ambient light and illuminate the front lights 217 and rear lights 221 when the ambient light is dark. For example, if a bicycle is ridden through a tunnel, it can be difficult to quickly turn the lights on manually. The automated system can perform this task immediately without any effort or actions required by the rider.

In an embodiment, the system can have a temperature sensor 249 and the system can display the temperature data on the display 205 when the rider selects the weather application or any other application that displays the ambient temperature. The temperature can also be used to determine the proper charging parameters. For example, all the electronic components must resist to extended expositions to temperatures in the range: −10° C.-50° C. In particular, for Li-Ion batteries these limits normally vary depending on how the battery is being used: during discharge: −10 ° C.-50° C. and during charge: 0-45° C. A way to protect batteries from working outside these ranges is to use the temperature measured by the bike sensor to reduce or interrupt (via BMS 235) the charge/discharge current of the batteries 237.

In an embodiment, the main electronic components such as the main board with processor 201, battery 237 and BMS 237 can be located inside the top tube of the bicycle frame. The bicycle may use an electronic gear shifting system. With electronic shifting, the shifting mechanisms can be powered with a separate battery. In an embodiment, the shifting system battery can also be located inside the top tube. However, in some embodiments, the shifting system can be powered with the main batter 237. For RF communications, antennas are required to transmit and receive the RF signals. The antennas can be located at the rear end of the top tube and possibly integrated into the rear light structure which will not block RF signals such as plastics or other suitable RF transparent materials. The display 205, with environmental light sensor 247 and its integrated controller can be located at the very top of the handlebar stem. A horn button can be mounted on a left side brake lever structure and a computer control joystick can be mounted on the top of the right brake lever structure. A plastic structure mounted on the head tube can house a horn 225, a temperature sensor 249 and a micro USB port 231. The horn 225 may require a conditioning circuit that can be part of the main board that can be inside the top tube. The front lights 217 are located on the front fork on the left and right fork legs. The dynamo hub 233 can be built into the front wheel of the bicycle.

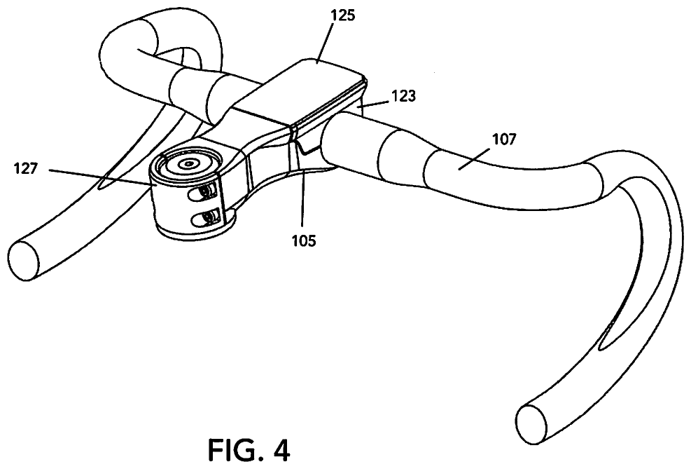

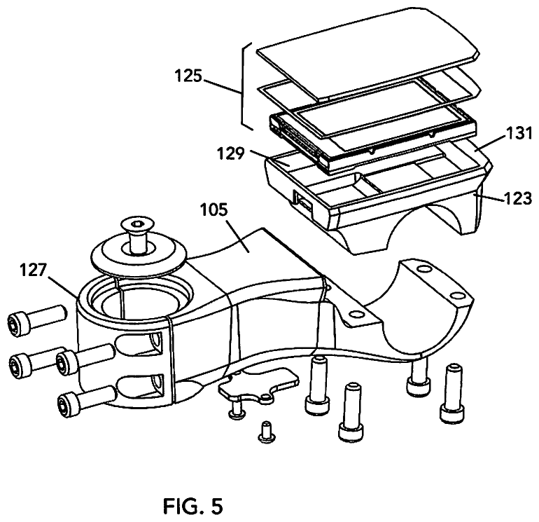

FIG. 4 illustrates a top perspective view of an embodiment of a stem 105 and a handlebar 107 and FIG. 5 illustrates an exploded view of an embodiment of a stem 105. In this example, the stem 105 is an elongated structure that has a rear portion which is coupled to the top of the steer tube and a front portion which is coupled to a handlebar 107. In this embodiment, the rear portion of the stem 105 has a vertical hole that the steer tube is placed into. The stem 105 can be secured to the steer tube with a steer tube clamp 127 that is coupled to the stem 105 with a plurality of bolts. To secure the stem 105 to the steer tube 109, the bolts can be loosened to expand the vertical hole. The stem 105 can be properly positioned on the steer tube and the bolts can be tightened to clamp the steer tube 109 to the steer tube clamp 127 and the stem 105. The steer tube clamp 127 can be semicircular in shape with the outer surface defining a convex 180 degree radius and the inner surface defining a concave 180 degree radius and a front surface of the steer tube clamp 127 can be planar and intersects the center point of the radius. The bolts can be aligned with the longitudinal axis of the stem 105 and the back surface of the stem 105 can define a plane that is perpendicular to the longitudinal axis of the stem 105. The front surface of the steer tube clamp 127 can also be planar and perpendicular to the longitudinal axis of the stem 105.

The front portion of the stem 105 includes an upper handlebar clamp 123 which can be coupled to the stem with a plurality of threaded bolts. The upper handlebar clamp 123 can have a semicircular inner diameter surface that is secured over the top of the handlebar and a lower surface that defines a plane that can be parallel to the longitudinal axis of the stem 105. The upper handlebar clamp 123 can be secured to the front of the stem 105, which includes a semicircular inner diameter surface that is secured under the handlebar and an upper surface that defines a plane that can be parallel to the longitudinal axis of the stem 105. A visual display 125 can be mounted to the upper surface of the handlebar clamp 123. The visual display 125 can be in various sizes typically ranging from 1 to 3 inches, but in other embodiments the visual display 125 can be any size.

In different embodiments, the stem 105 can be manufactured in different ways such as: CNC machining, die-casting, etc. and from different materials such as aluminum, steel, titanium, etc. The upper handlebar clamp 123 can have a rectangular recess 129 where the visual display assembly 125 can fit. The visual display assembly 125 can include just the display only or display plus its electronic graphic processor. The display assembly 125 can be closed and sealed by a thin glass piece on the upper surface or any other suitable transparent material such as plastic. Cables, in some embodiments, can exit the upper handlebar clamp 123 from one or more hole passageways.

The recess 129 can be surrounded by a raised edge 131. A display processor and other system components can be mounted within the recess 129 below the visual display 125. The visual display 125 can be attached to an upper surface of the raised edge 131 above the recess 129. The outer perimeter of the visual display 125 can fit within an outer raised lip 132 with the inner surface of the raised lip being less than 1 mm greater than the outer dimensions of the visual display 125 so that the visual display 125 fits within the outer raised lip. The outer raised lip can be have a height that is greater than the thickness of the visual display 125 so that the visual display 125 is mounted within the upper handlebar clamp 123 and the upper edge of the raised lip will be higher than the upper surface of the visual display 125. Thus, the visual display 125 will be recessed and protected by the raised lip.

In some embodiments, the visual display 125 can be used as a visual feedback device to interact with the bicycle smart features, software and application programs (apps). For example, the visual display 125 can be configured to display riding metrics, weather forecast, travel or destination directions, music playback information, etc. The bicycle, in some embodiments, includes one or more of the following embedded smart features and accessories: fully integrated built-in digital color display, a series of native apps (such as Live Performance, Navigation, Health, Live Forecast, Media, Odometer, MP3 reader and others), integrated and smart front and rear light system, integrated horn mechanism, embedded mechanical and/or software lock mechanism, real time GPS tracking, motion based anti-theft systems, etc.

Because the fully embedded display 125 is securely attached to and integrated with the upper handlebar clamp 123 or other parts of the bicycle, the electrical components including: the main processor, the display processor, GPS and other electronic components can be a permanent part of the bicycle and cannot be easily separated from the bicycle and stolen. This integrated system is much more convenient because the user does not need to remove and reattach the electronic components when riding. In a first embodiment, the system may include a display processor and a main processor that communicate with each other.

In different embodiments, the bicycle can include a front lighting system. While the front lighting system is illustrated and described with reference to a road bicycle, in other embodiments, this lighting system can be used with any type of bicycle including: conventional fully man powered, electric motor assisted, or fully electric bicycle vehicles with embedded electronics.

In an embodiment, the front lighting system can be integrated into the fork of the bike. The front lighting system may also include a light sensor that can trigger the activation of the front lights. For example, when dark ambient conditions are detected the processor can receive a signal from the light sensor that informs the system that the bicycle is moving through a dark area. The main process can respond to this input by automatically turning on the front lights. In some embodiments the light output from the front lights can be controlled based upon the detected ambient light level. In some embodiments, the processor may be configured to control the front light outputs to be inversely proportional to the ambient light. For example, if the light sensor detects ambient light to be 30% of maximum light, then it can control the front light output to be 70% of maximum light output. If the ambient light is 80% of maximum light, then the system can be configured to emit 20% of the maximum light output. The processor can be configured to control the front lights to emit different luminous intensities depending on the environmental light. The light sensor can be based on various different technologies including: photoresistor, lux sensor, or any other suitable ambient light sensor.

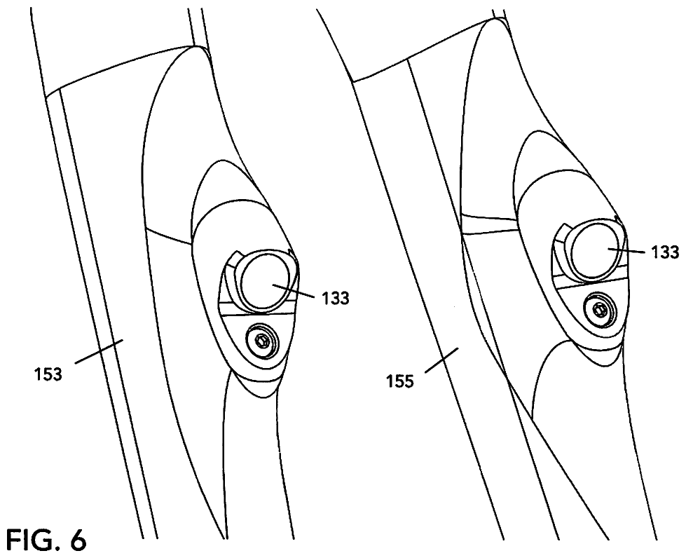

An embodiment of the front lights located in front surfaces of the bicycle fork is illustrated with reference to FIGS. 6 and 7. FIG. 6 illustrates a front lighting system that includes a left light source 133 mounted on a front surface of a left fork leg 153 and a right light source 133 mounted on a front surface of a right fork leg 155. In this embodiment, the left fork leg 153 and the right fork leg 155 have recesses for the light sources 133 which are on the forward edge of the fork legs and the light sources 133 are at an acute angle relative to the front surfaces of the fork legs.

FIG. 7 illustrates an exploded view of an embodiment of the light source 133 components which can include a light housing 134 that can be built into the fork leg, a light mounting plate 135, an LED mounted on a printed circuit board (PCB) 143, a lens 145, a gasket 147 and a cover 149. The LED on the PCB 143 can fit within the housing 134 formed in the fork leg. A lens 145 can be placed on the PCB 143 over the LED light. A gasket 179 can be placed between the housing 134 and the light cover 149 to provide a water tight seal so water cannot flow into the light source 133. The light cover 149 can be secured to the housing 134 with a threaded screw. In this example, the top of the light cover 149 can have a tab that is placed into a slot formed in the housing 134. The tab and slot interface can hold the top of the light cover 149 to the housing 134. The screw can be tightened to compress the gasket 179. The light mounting plate 135 can be made of aluminum, which provides good thermal conductivity so that the light mounting plate 135 can function like a heat sink for the front lights and the lighting system components do not overheat and fail. In an embodiment, a thermal paste can be applied between the components to improve the thermal conductivity between the LED light and PCB 143 and the light mounting plate 135. In an embodiment the thermal conductivity can be between about 190-220 (W/mK). The light mounting plate 135 can function as a heat sink to prevent the light and other system components from exceeding a temperature of about 100 C. The light output for each light source 133 can be between about 100 to 600 lumens which can provide sufficient light but prevent overheating of the light system components.

The fork can be made of various different materials including: Aluminum, Steel, Carbon Fiber, or many other kinds of composite material. The light mounting plate 135 heat sink interface with the fork legs can be glued, welded, snap fit, thermally coupled, etc. The heat dissipation properties of the light mounting plate 135 can depend upon the thermal properties of the fork material. For example, carbon fiber does not dissipate heat very well and a larger light mounting plate 135 can be required for front lights 133 to be used with carbon fiber forks. In contrast, aluminum has good heat dissipation properties and therefore a smaller light mounting plate 135 can be used with aluminum forks.

The lens 145 can be positioned over the LED light to focus the light emitted from the LED forward and towards the ground. In some embodiments, the lenses 145 may direct and focus the light toward specific directions to optimize the road visibility for the rider. For example, the lenses 145 may separate the light emitted by the left and right lights so that excessive light is not directed through the front wheel, which will block the light. More specifically, the left lens 145 may direct the left light forward and to the left while the right lens may direct the right light forward and to the right. In the illustrated example, the lens 145 has a circular shape.

The light emitting by the light sources 133 can be controlled by the electrical power applied, the lights 141 and the lenses 145. In different embodiments, the lights 141 and lenses 145 can be interchangeable and different lights 141 and lenses 145 can be used with the lighting system depending upon the application or personal preference of the cyclist. Bicycles being ridden over dark unpaved narrow trails may require more focused light because they are traveling through a narrow path than bicycles being ridden on congested metropolitan roads where visibility by other vehicles may be more important than road visibility.

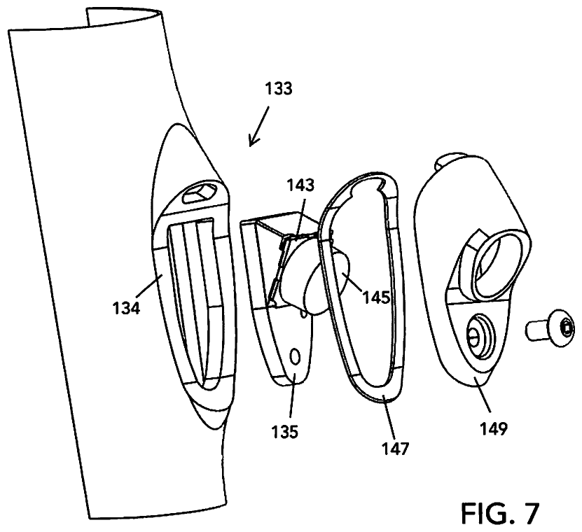

With reference to FIG. 8, the position of the front lights 141 partially down the lengths of the left fork leg 153 can provide improved visibility for the cyclist. For example, the distance between the lights 141 and the distal end of the left fork leg 153 (and the right fork leg) can be less than 400 mm. In the illustrated embodiment, the lights 141 can be between about 100 mm to 400 mm from the distal end of the left fork let 153. This lower light position can provide improved visibility for the rider. The front lights 141 are emitting rays of light 157 forward towards the ground 163. When the light rays 157 strikes an object 159, it illuminates the object 159 and casts a shadow 161 behind the object 159. The ability of the cyclist to see objects is important to avoid collisions. Because the cyclist is much higher than the front lights 141, the rider's line of sight 164 can allow the riders to see the dark shadows 161 in addition to the object 159. The ability to see the dark shadow 161 can improve the visibility of objects 159. A problem with a light that is mounted near the cyclist's eyes is that the light and viewing angles are the same so shadows from these higher positioned lights are not visible to the cyclist.

When the bicycle is being ridden, the wheel 222 rotates and the lights 141 illuminate the spokes 224. The light rays 157 can contact the spokes 224 at a plurality of light incident points 226 and the light is reflected outward. This reflected light will improve the visibility to viewers such as other bicyclists and cars on either side of the bicycle. The movement of the incident points 226 will also increase the bicycle visibility. This Currently there are no known bicycle forks with integrated lights on each fork leg that are commercially available. A few bicycles have a front light embedded in the handlebar. However, these higher light source system will not provide the described benefits of improved road debris visibility for the rider or the reflective spoke visibility for other people.

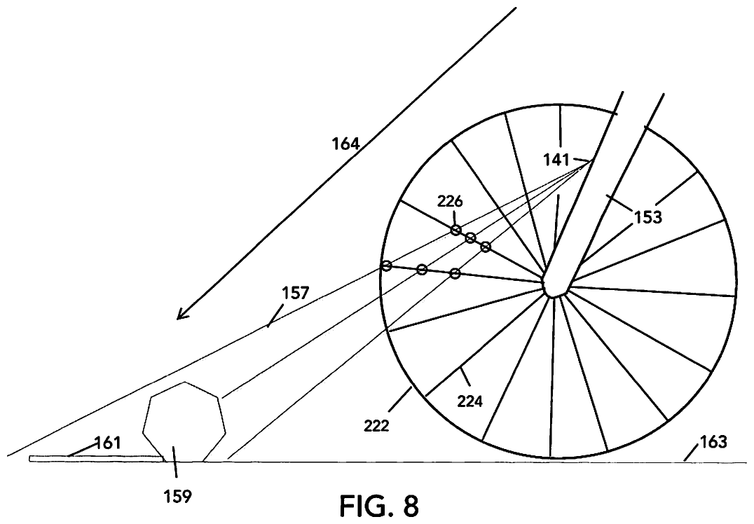

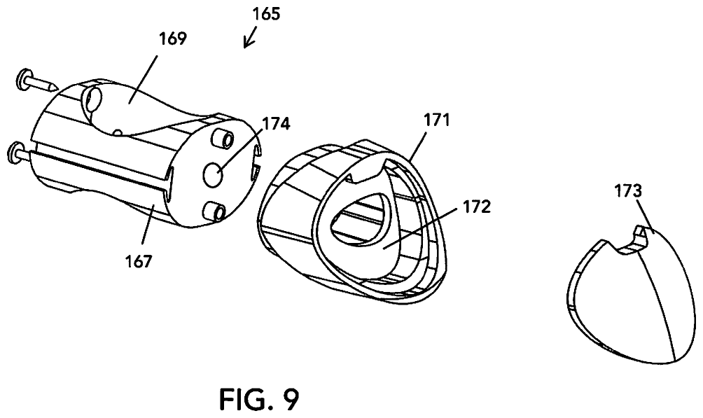

The inventive bicycle can also include an integrated rear lighting system. With reference to FIG. 9, an embodiment of the rear light assembly 165 is illustrated that fits within a rear end of the top tube of the bicycle frame. In an embodiment, the rear light assembly 165 can have mechanical housing 167 which holds the electronic components such as Printed Circuit Boards, light, heat sink, lens, etc.). The housing 167 may also include a vertical seat post hole 169 that is aligned with the upper seat tube and the lower seat tube. As shown in FIG. 1, the upper seat tube 117 can have a smaller inner diameter than the inner width of the top tube 113 which can be circular, oval or have any other cross section geometry. The vertical seat post hole 169 can have a wider inner diameter than the inner diameter of the upper seat tube 117 so that a seat post can have a close fit with the upper seat tube 117 and a loose fit within the seat post hole 169. In some embodiments, the components of the system attached to the housing 167 can be kept in place within the bicycle frame by the seat post that is inserted through the seat post hole 169 in the housing 167. To access the components on the housing 167, the seat post may be removed from the seat tube and then the rear light assembly 165 can be removed from the top tube of the frame. To reassemble the bicycle, the rear light assembly can be inserted into the top tube and the seat post can be inserted into the seat tube and the seat post hole 169 in the housing 167.

The light rear light assembly 165 can be inserted into the top tube 113 with the rear portion 171 of the housing 167 extending from the rear edge of the top tube 113. The portion of the housing 167 forward of the rear portion housing 171 can have a cross section, which fits within the top tube 113. In contrast, the rear portion housing 171 can have a cross section that is at least partially wider than the inner surfaces of the top tube 113. The rear portion housing 171 can include a rear light lens 173, which directs light back from the bicycle. Rear lights can emit red wavelength light so the rear light lens 173 can be made of a clear transparent plastic. Alternatively, the rear light can emit white light and the rear light lens 173 can be red translucent plastic so that the emitted light is red. The rear portion housing 171 can have a recessed rear light mounting surface 172. A PCB with rear LED lights can be mounted on the rear light mounting surface 172. Wires to the rear LED light PCB can be passed through a center hole formed in the rear portion housing 171. The rear lens 173 can be recessed within the protective housing 167, which can protect the rear lens 173 from impact and damage from contact with other objects. The rear lens 173 and housing 167 may direct light back away from the bicycle but also allow the rear light to be viewed from the sides so that the bicycle will be visible to cars and other people on the sides of the bicycle. In an embodiment, the bicycle may include a high definition (HD) wide angle rear facing camera 174 that can be mounted on the housing 167.

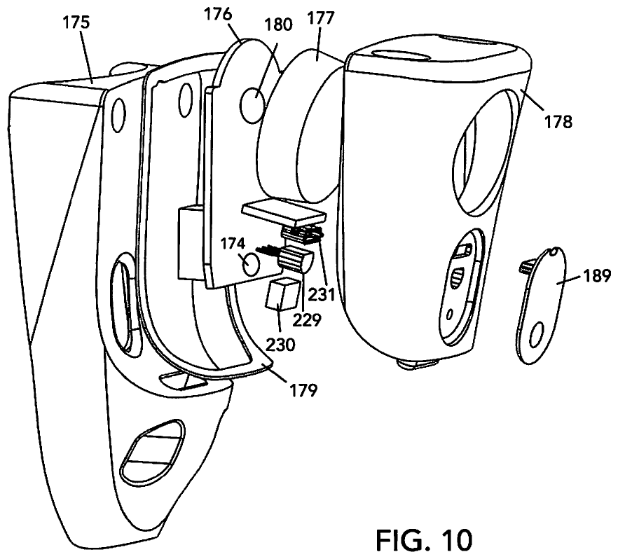

FIG. 10 illustrates a front perspective exploded view of an embodiment of a front assembly that can include a bracket 175 that can be mounted on a head tube of the bike frame, a printed circuit board (PCB) 176, a horn 180, a horn resonator 177 and front cover 178 and a gasket 179. A PCB 176 can be mounted to the head tube mounting bracket 175 and the horn 180 can be mounted on the PCB 176. The head tube mounting bracket 175 can include a plurality of holes that can provide mounting features and passageways for electrical cables. For example, fasteners can be placed through one or more of the holes and the screws can be used to secure the head tube mounting bracket 175 to the head tube 111. The head tube mounting bracket 175 can also include components such as a horn controller, a horn 180, a micro USB port 231 and a light sensor 229 and a temperature sensor 230. In an embodiment, the bicycle may include a high definition (HD) wide angle front facing camera 174 that can be mounted on the PCB 176.

For improved audio output, an electric horn 180 can be mounted to the front surface of the head tube mounting bracket 175. The horn 180 can receive electrical signals from the processor in response to a user horn input control. In an embodiment the horn 180 can be a piezo electric buzzer. When actuated, the horn 180 can emit an audio output that causes the horn resonator 177 that is positioned over the horn 180 to vibrate. The horn resonator 177 can both protect the horn 180 and amplify the audio output of the horn 180. The resonator 177 can be positioned within an opening in the front cover 178 so that the audio output is free to travel forward. In the illustrated example, the resonator 177 has a cylindrical shape that has an outer diameter that fits within an inner diameter in the front cover 178. The PCB 176 can also have other components including a micro USB port 231 which can be connected to a power supply for externally charging the battery and/or a communications connection for sending or receiving data. The light sensor 229 can detect ambient light and as discussed the system can be configured to automatically illuminate the front and/or rear lights when the detected ambient light is below a predetermined value. In an embodiment, a removable component cover 189 can be placed over the micro USB port 231 and the light sensor 229 to protect these components from the elements but still allow the light sensor 229 to detect ambient light levels. The FIG. 11 illustrates a front perspective view of an embodiment of a head tube mounting bracket 175 on a head tube 111 of the bike frame 102 with the resonator 177 positioned within a hole in the front cover 178 and the component cover 189 over the USB port and light sensor.

As discussed, the present invention can have user inputs that are integrated into the bicycle in locations that are easily accessible to the cyclist. For example, the user inputs can be built into the bicycle's handlebar or components attached to the handlebar. Because the cyclist is normally holding the handlebars, the input controls can be easily accessed while riding the bicycle. This type of input can allow a user to control all of the bicycle's integrated features installed on the bicycle itself. FIG. 11 illustrates an embodiment of a right brake lever assembly 181 and a left brake lever assembly 183. The right brake lever assembly 181 and the left brake lever assembly 183 are attached to handlebars 107, which is attached to a stem 105. As discussed, the electrical systems can be controlled by a main processor and a display processor by a user through a user input which can be integrated into the right brake lever assembly 181 and/or the left brake lever assembly 183. In an embodiment, the user input can include a control unit, such as a joystick 185 which can be mounted on the very top of the right brake lever assembly 181 and a control button 187 mounted on the top of the left brake lever assembly 183. In an embodiment, the control button 187 can be an electrical switch, which can be pressed to actuate the horn and cause an audio output to be emitted through the resonator 177 as described above. The control button 187 can be released to stop the horn's audio output. The joystick 185 can allow a user to interact with a user interface of the system. Although the system has been described as having a joystick 185 in a right brake lever assembly 181 and a push button 187 in a left brake lever assembly 183, in other embodiments, these controls can be reversed on the left/right brake levers or combined in any manner. For example, the system may utilize two joysticks 185 on both the right brake lever assembly 181 and the left brake lever assembly 183. In other embodiments, other electro-mechanical control mechanisms can be used to control the bicycle's electrical systems as well. In still other embodiments, the joystick 185 and control button 187 can be located on different areas of the right brake lever assembly 181 and the left brake lever assembly 183. For example, these user controls can be positioned on a lower or inner surface of the the right brake lever assembly 181 and the left brake lever assembly 183.

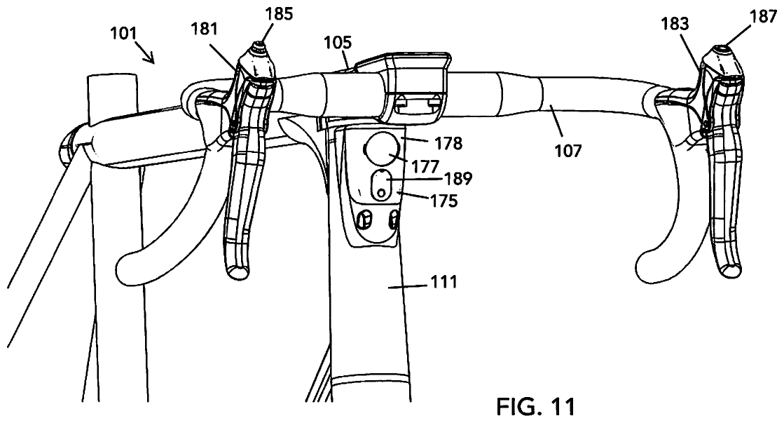

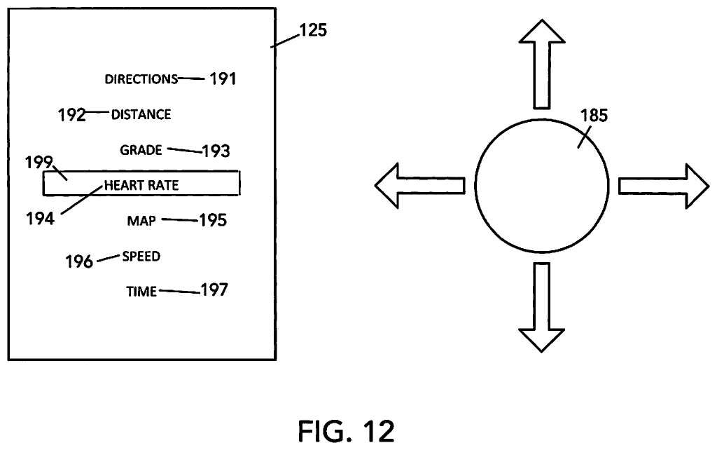

With reference to FIG. 12 a top view of an embodiment of a joystick 185 and a visual display 125 are illustrated. The joystick 185 can be controlled by the user's thumb, which can be placed on the right brake lever assembly. The joystick 185 can be spring loaded so that it is normally in the center upright position. The joystick 185 can also be moved left, right, up, or down by the user as indicated by the arrows surrounding the joystick 185. The joystick 185 can transmit user interface control signals to the processor, which are then transmitted to the display processor and display 125. In an embodiment, the display 125 can display system information and the user can use the joystick 185 to select the desired information to display. For example, in this example, the user interface of the system is displaying a list that includes: directions 191, distance 192, grade 193, heart rate 194, map 195, speed 196 and time 197. The joystick 185 can be moved up or down to move a highlight indicator 199 to one item on the list. The joystick 185 can be moved left or right to change the data listing being displayed. In this example, the highlight indicator is on heart rate 194. If the user wishes to see the heart rate data, the user can press the joystick 185 to select the heart rate 194 and the system will respond to displaying the user's heart rate on the display 125. If the user wishes to see some other information on this screen, the user can move the joystick 185 up or down to the desired information. Once the desired information is highlighted 199, the user can put the joystick 185 in to cause the system to display the requested information on the display 125. The joystick 185 and control button 187 offer a safe and reliable means for controlling the electrical and computer systems which can improve the user's riding experience around the city and/or outside the city and/or between cities.

The bicycle can have numerous different operating modes. In an embodiment, the system can be configured with three different operating modes: Riding Mode, Standby Mode and Antitheft Mode. The system components can be actuated based upon the operating mode. For example, in the riding mode, the system can actuate the GPS tracking, data exchange for weather, heart rate and directions. The system can also exchange data via GPRS and sensors. With this information the processor can perform calculations to determine and display additional data including: calories consumed, average speed, maximum speed, etc.

In the standby mode, when the bike is on but sleeping while waiting for an input by the user the bicycle can be resting and can be waiting to be ridden and the display may be blank and turned off to conserve power. The system sensors can then be in a standby mode waiting to receive a signal from any one of the system sensors including Bluetooth, GPRS, and read sensors. When the bicycle detects that the rider is going to use bicycle again, these electrical systems can be reactivated and the mode can automatically be switched to riding mode.

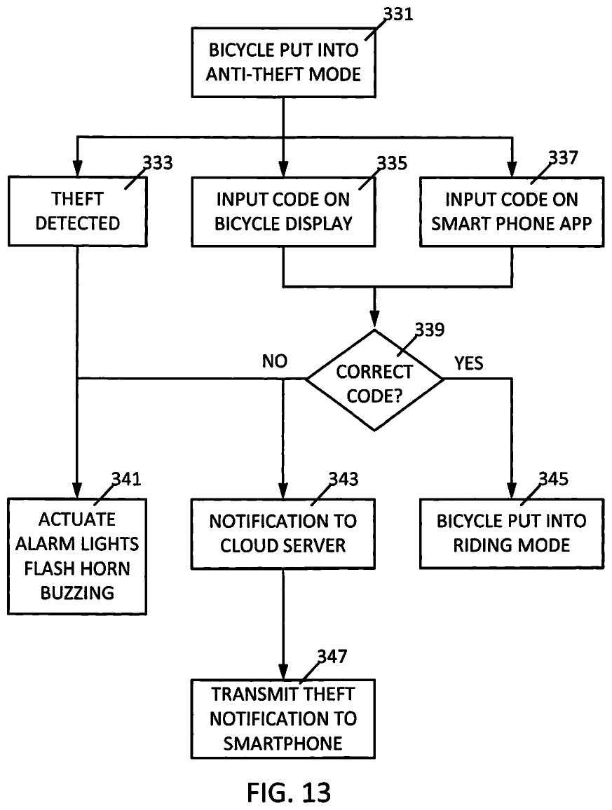

With reference to FIG. 13, a flow chart for the bicycle in the antitheft mode is illustrated. The user can convert the bicycle to the antitheft mode 331 through a smart phone application or through the user interface and display on the bicycle. The user may need to input a security code into the smart phone or user interface to actuate the antitheft mode 331. In an embodiment, the user may have programmed the system with an access code that must be properly input before the electrical systems enter ride mode. In an embodiment, the code may be input through the joystick 335. Alternatively, in an embodiment the system may allow the user's mobile phone to communicate with the system through RF communications such as Bluetooth transceivers. When the user within the transition range, the mobile phone input can be used to enter the predetermined access code 337. The system can determine if the user input code is correct 339. If the access code is correct, the bicycle can be placed in the riding mode 345. However, if the improper access code is input possibly multiple times or if a theft is detected 333, the system can respond by emitting an alarm which can include emitting an alarm sound through the buzzer and flashing the front and rear lights and displaying warnings 341. In an embodiment, the theft 333 can be detected by an accelerometer that detects any unauthorized movement of the bicycle.

In antitheft mode, the electronics are locked and the bike can play an alarm when an attempted theft is detected. In an embodiment, the bicycle can include an accelerometer sensor, which is actuated when the bicycle is moved. If the bicycle is moved without authorization, the bicycle can interpret this as an attempted theft 333 and respond by emitting an alarm sound through the buzzer and flashing the front and rear lights and displaying warnings 341. The bicycle can also respond to an incorrect code and detected theft 333 by transmitting a theft notification with the bicycle location information as an RF signal to a cloud server 343 which can be operated by a service provider. The theft notification with bicycle location information can also be transmitted to the owner of the bicycle through a cellular transmission to the true owner's smart phone 347. The user can continue to obtain location information to the smart phone from the GPS on the bicycle as the thief moves the bicycle. The owner can receive a theft notification then use the bicycle's location information to recover the bicycle or inform law enforcement officials of the location of the bicycle.

In the riding mode, the user is riding the bicycle and the system can display data as instructed by the computer software application (App) that is running on the processor. The system may also provide the user with notifications of phone calls. The system may also allow the lights and horn to operate in response to the user controls. The user may use a joystick to scroll through various system functions and the user can select any of the stored computer software applications. In an embodiment, the system can include one or more of the applications listed in Table 1 below.

TABLE 1

| Application | Actions |
|---|---|
| Performance | Determine And Display Performance Data |
| Trip Data | Obtain And Display Trip Data From GPS |
| Health | Obtain And Display User Heart Rate Data |
| Directions | Obtain And Display Direction Data |
| Weather | Obtain And Display Weather Data |
| Media | Obtain And Display Media Data |
| Odometer | Obtain And Display Distance Data From GPS |

In an embodiment, the application and operating system software can be updated by RF communications to the system. For example, the system may be linked to a smart phone and the system can be notified that a software update is available. The user interface can ask the user to authorize the download of the software update through the smart phone or the display on the stem. If approved, the software update can be downloaded from a server(s) to the smartphone or directly to the system electronics and stored in memory. The downloaded software can be transmitted to the bicycle through the USB port, RF communications such as Bluetooth or any other suitable communications means. The system can download the software update(s) and inform the user when the software update(s) is complete. Once the software has been successfully updated, the electronic systems will be functional and the different operating modes will be available.

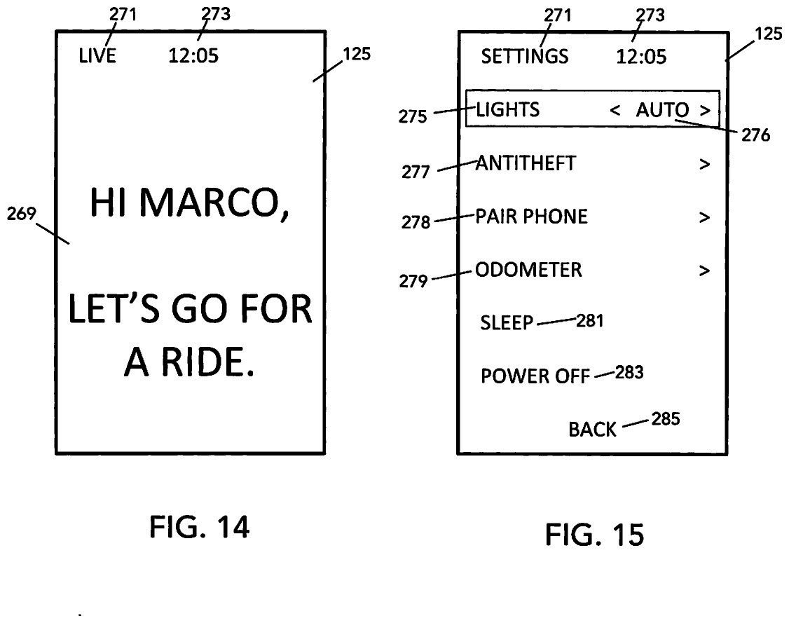

The operation of the system can be illustrated with reference to FIGS. 14-21, which illustrate various outputs for the system apps on the display, which provide information to the user. With reference to FIG. 14, the user can move the bicycle, which was in a standby mode, to wake the system and change the system to riding mode. In the example, the visual display 125 can be configured to know user information and display a greeting page 269, “HI MARCO, LET′S GO FOR A RIDE.” The system can display an app identity 271 and the time 273. In this example, the app identity 271 is “LIVE” and the time 273 is 12:05. With reference to FIG. 15, in the riding mode, the app identity 271 is “SETTINGS” and the user can use the controls to configure the system settings, which can include personal preferences for the lights 275, antitheft operation 277, phone pairing 278, and odometer 279. The user can move the joystick up or down to scroll to the desired function and then left or right to control the setting. In this example, the user has scrolled to lights 275 and then moved the joystick left or right to get to the AUTO setting. The other preference settings can be configured using this process. The user may also put the system to sleep by scrolling to and clicking on the sleep button 281 with the joystick or power off by scrolling to and clicking on the power off button 286. The user can exit the setting page by scrolling to and clicking on the back button 285.

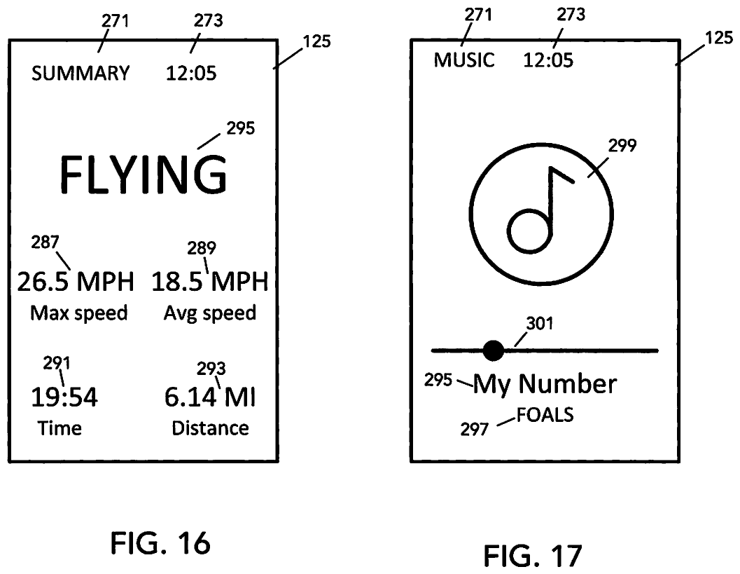

With reference to FIG. 16, the performance app can be running while the user is riding the bicycle. The performance app identity 271 can be “SUMMARY” and the app can display performance data for the ride including: maximum speed 287, average speed 289, ride time 291 and distance ridden 293. The system may also display a description of the current riding status 295. In this example, the system is describing the current riding status 295 as “FLYING.” Various other descriptions can be used to describe the riding status 295 including: Slow and Steady, Climbing Hard, Coasting, etc. In some embodiments, the system may know road information and convey this information to the rider. Road information messages can include: Approaching Accident, Approaching 25 MPH School Zone, Approaching Road Construction Zone, etc. In an embodiment, the system can obtain the performance data from the GPS signals obtained from a GPS receiver. Based upon the changes in position and time data, the system can calculate the performance data. In an embodiment, performance data such as power output can be based upon the rider weight, which can be input in the settings page. The system may allow the user to display any other performance data on the visual display 125 through the settings page.

With reference to FIG. 17, the app identity 271 can be “MUSIC” and the visual display 125 can show information about the music currently being played. In an embodiment, the system can be paired with a phone or other device that can play music. The system can then display the music information such as the title of the song 295 and the artist 297. In this example, the song title 295 is My Number and the artist is Foals 297. The system may also display cover artwork 299 for the song. The system may also display music controls 301 which can be manipulated to alter the playback. For example, the system can move forward or backwards within a song or access playlists, skip forwards/backwards in a playlist, etc.

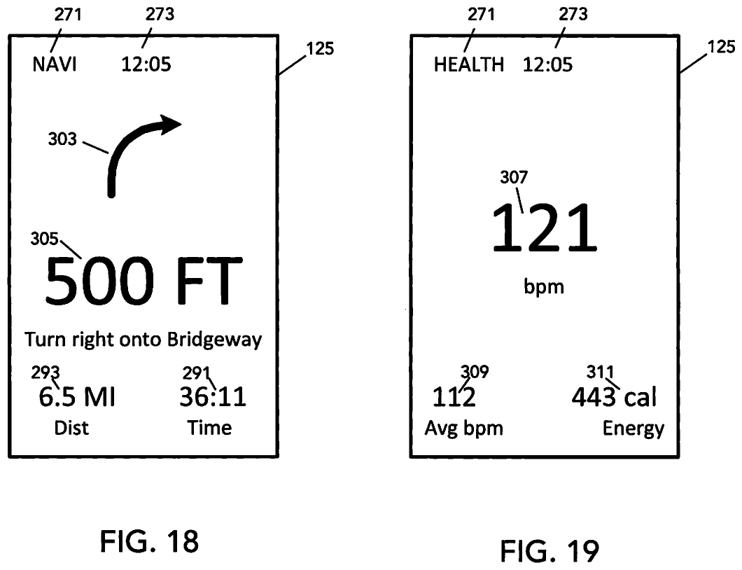

In an embodiment, the system or a smart phone can be set to provide directions from a start point to a destination. With reference to FIG. 18, the app identity 271 can be “NAVI” for navigation, and the system can display direction information. The system can tell the rider to turn as indicated by a direction arrow 303 and text 305. In this example, the arrow 303 can indicate a right turn and the text 305 can indicate right turn in 500 feet onto Bridgeway Street. The navigation page can also provide distance traveled and elapsed time on the visual display 125.

With reference to FIG. 19, a rider health page is displayed which is configured to provide heart rate information. The app identity 271 is “HEALTH.” In this example, the display 125 is showing a heart rate 307 of 121 beats per minute (BPM). The system is also showing the rider's average heart rate as 112 BPM and the energy consumed during the ride 311 is 443 calories.

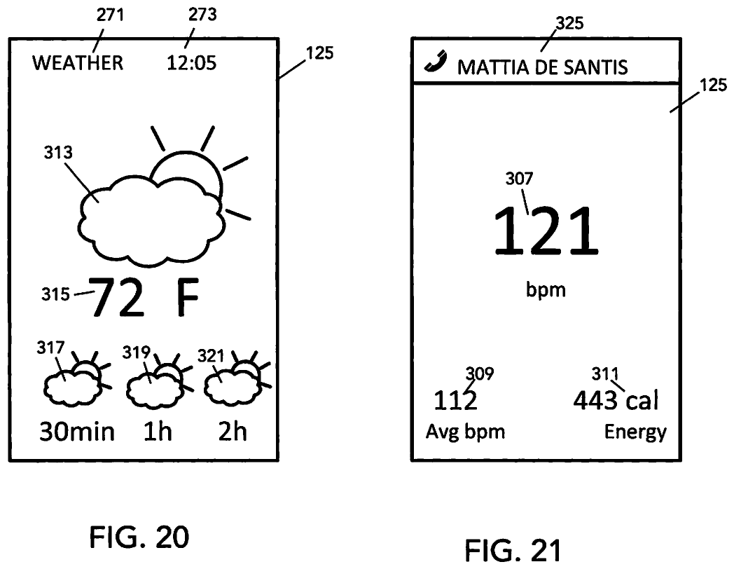

With reference to FIG. 20, the visual display 125 has been switched to a weather app as indicated by the app identity 271 “WEATHER”. The system can display a current weather icon 313, current temperature 315 and future weather icons 317, 319, 321. In this example, the current weather is partially cloudy as indicated by the center weather icon 313. The current temperature 315 can be detected from an integrated temperature sensor. In this example, the detected temperature is 72 degrees Fahrenheit. The predicted weather in 30 minutes, 1 hour and 2 hours will be partially cloudy as indicated by the 30 minute icon 317, the 1 hour icon 319 and the 2 hour icon 321. In other embodiments, the weather app can be configured to display other types of weather information. By reviewing the weather app, the user can determine if there will be any weather issues during the bicycle ride. For example, the user may cancel or turn around early if bad weather is predicted. In an embodiment, the weather information can be obtained directly through the cellular receiver and in other embodiments; the system may obtain weather information from a paired smart phone through an RF transceiver such as a Bluetooth connection.

With reference to FIG. 21, the system can be paired to a smart phone and if a phone call is received while the bicycle is in the ride mode, the system can display call information 325. In this example, the visual display 125 is on the health app and the call information 325 indicates that a phone call has come in from Mattia De Santis. The user can click on the call information 325 to answer the phone call or the user can ignore the call information 325 to allow the phone call to go to voicemail.

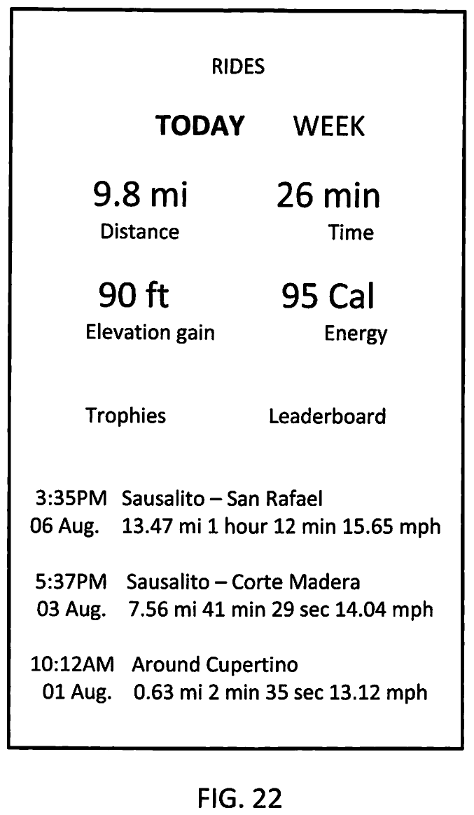

With reference to FIG. 22, a ride page can be accessed on the user's smart phone. In this example, the user interface can list the user's past rides by day, week, month, etc. In this example, the user has selected information to today's ride which lists 9.8 miles ride distance, 26 minutes ride time, 90 feet of elevation gain and 95 calories of energy consumed. The user interface page can also display summaries of the user's recent past rides which can list the time, date, travel locations, ride distance, ride time and average ride speed. The user can swipe on any of these rides to obtain more detailed ride information. The user can also scroll down to access additional ride data. The user interface can also provide trophies for user ride accomplishments and a leaderboard that can list the fastest rider data for courses that have been ridden by the rider. In an embodiment, this information can be transmitted to a cloud server and this information can then be transmitted to social network websites such as Stava™ and/or cell phone and/or servers of friends, coaches or other people who may request the rider information.

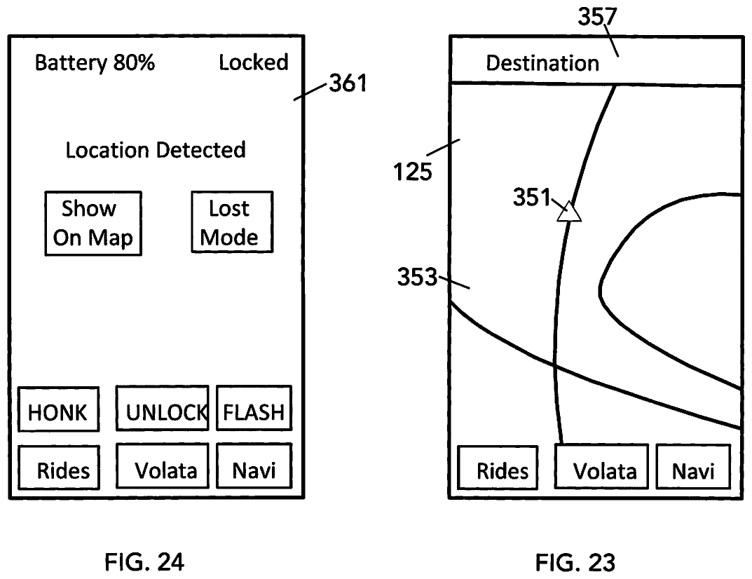

With reference to FIG. 23, in the navigation mode, the visual display 125 can be configured to display a map 353 with streets and other physical features such as water ways. The user's location 351 can also be displayed on the map 353 so that the rider can have a visual frame of reference. In this example, the user interface may have a destination input 357 which can allow the user to input the destination. The system can respond by to the destination input by providing direction from the user's location to the destination.

With reference to FIG. 24, when a user has put the bicycle into an anti-theft mode, the system can continuously transmit security information to the user's smart phone. The bicycle information can be processed by a mobile application program running on the smart phone which can have a user interface 361. In this example, the mobile application 361 can display the battery charge level which is currently 80%. The status of the bicycle as “Locked” can also be displayed. The user interface 361 can have specific controls that can help the user locate the bicycle such as “show on map” which can be actuated to display a map that shows the location of the bicycle. If the user cannot find the bicycle the user can click on the “Lost Mode” button which can cause the bicycle to emit current location information to the server which can then be transmitted to the user's smart phone. The mobile application can also provide system controls. If the user clicks on the honk button, the control signal can be transmitted to the server which can transmit a honk signal to the bicycle which can respond to actuating the horn to emit audio signals. The user may click on the “Flash” button which can cause the bicycle to flash the lights which can be useful to help locate the bicycle in a dark parking area. When the user wishes to ride the bicycle, the “Unlock” button can be actuated to cause the bicycle mode to be switched from anti-theft mode to ride mode as described above.

TABLE 2 below illustrates examples of the operation and possible power consumption of the different components in the different operating modes of the system's electrical components.

TABLE 2

| | Ride Mode | Anti-Theft Mode | Standby Mode |
|---|---|---|---|
| Dynamo | 3 Watts @ 6 Volts | 0 Watts | 0 Watts |
| Output | at 10 mph speed | | |
| MCU + All | ON | ON | Partially ON |
| Sensors | | | |
| Display | ON | OFF | OFF |
| GPS | ON - Continuous | ON - Occasional | ON - Occasional |
| | Tracking | Check | Check |
| Bluetooth | ON - Continuous | ON - Occasional | ON - Occasional |
| | data transfer | data transfer | data transfer |
| Front Lights | ON 2 × 350 mA | Normally OFF | OFF |
| | @ 3 V | | |
| Rear Light | ON 150 mA @ 3 V | Normally OFF | OFF |

While the present invention has been described with reference to high-tech bicycles, or smart bikes, which is a bicycle that can be either a conventional human powered or with electric-assist motor, or fully electric with embedded electronics, in other embodiments, the inventive features can be used with other vehicles such as motorcycles. The bicycle features, in some other embodiments can include a microcontroller unit that manages various electronic features that enable the bike to be connected to the Internet (via GPRS or any other suitable cellular RF communication means) and/or to a smartphone (via Bluetooth or any other suitable short range high efficiency RF communications means).

In some embodiments, the described bicycle may also include additional systems and features. For example, many cities now have bike sharing programs and the system can be configured with a bicycle sharing App. The system may include embedded mechanical and/or software lock mechanisms. For example, when a bike theft is detected or actuated by a user, the system can lock certain components including the display and electronic shifting components so that the bicycle is no longer operable. In an embodiment the bicycle can have a n integrated energy storage system inside the bicycle frame that can provide stronger signal communications in the event that the rider is away from a cellular network and needs assistance. The bicycle may also have an integrated motor which can provide propulsion assistance. In some embodiments, the propulsion system can be an electric motor which can be mounted in the seat tube or down tube to provide rotational assistance to the cranks of the bicycle. The bicycle may also include solar panels which can be mounted on upper surfaces of the frame to help charge the batteries.

While the locations of the electronic components within the frame or other structures of the bicycle have been identified, in other embodiments, the electronic components and other devices can be mounted in structures that are external to the frame such as: fake water bottles or various kinds of external bags. If the system components are within the frame, in some embodiments, the frame can have have doors, flaps or other mechanisms that can give a user access to the electronic components.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present disclosure, in various embodiments, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation. Rather, as the flowing claims reflect, inventive aspects lie in less than all features of any single foregoing disclosed embodiment.

What is claimed is:

1. A bicycle comprising:
a stem having a proximal portion and a distal portion, the proximal portion is coupled to a steer tube of the bicycle, the proximal portion is coupled to a handlebar of the bicycle;
a display is coupled to an upper surface of the distal portion of the stem;
a graphics processor that is coupled to the display and the stem wherein a user interface controls information that is displayed on the display;
a main processor coupled to the graphics processor;
a battery providing electrical power to the graphics processor and the display;
a global positioning system (GPS) coupled to the main processor for providing location information; and
a memory coupled to the main processor for storing the software.

2. The bicycle of claim 1, further comprising:
a dynamo hub connected to a wheel of the bicycle and the battery, wherein the dynamo hub charges the battery.

3. The bicycle of claim 1, further comprising:
a fork coupled to a front wheel of the bicycle and the steer tube; and
a lighting system integrated into the fork.

4. The bicycle of claim 3, wherein the lighting system includes:
a right light emitting diode (LED) coupled to the battery and integrated into a right leg of the fork; and
a left LED coupled to the battery and integrated into a left leg of the fork.

5. The bicycle of claim 4, wherein the lighting system includes a right heat sink coupled to the right LED and the right left of the fork and a left heat sink coupled to the left LED and the left of the fork.

6. The bicycle of claim 4, wherein the right LED and the left LED are between 100 mm and 500 mm from a distal end of the fork.

7. The bicycle of claim 4, wherein the right LED and the left LED are each have a light output between 100 lumens and 600 lumens.

8. The bicycle of claim 1, further comprising:
a top tube having a rear portion; and
a rear lighting system integrated into the rear portion of the top tube.

9. The bicycle of claim 8, further comprising:
an upper seat tube that intersects the rear portion of the top tube; and
a lower seat tube that is axially aligned with the upper seat tube and intersects the rear portion of the top tube; and
a seat post that is placed in the upper seat tube;
wherein the rear lighting system includes a hole that is axially aligned with the upper seat tube and the seat post is placed within the hole.

10. The bicycle of claim 1, further comprising:
an accelerometer coupled to the processor for detecting acceleration, where the accelerometer is aligned with a longitudinal axis of the bicycle and the software detects collisions of the bicycle and emits a crash output signal when the acceleration detected by the accelerometer is greater than 20 m/s^{2.}

11. The bicycle of claim 10, further comprising:
a radio frequency (RF) transceiver wherein the crash output signal is transmitted from the RF transceiver.

12. The bicycle of claim 1, further comprising:
a radio frequency (RF) transceiver wherein ride data is transmitted from the RF transceiver.

13. The bicycle of claim 1, further comprising:
a buzzer coupled to a head tube of the bicycle, wherein the buzzer is powered by the battery.

14. The bicycle of claim 13, wherein the buzzer is configured to direct a higher amplitude audio signal forward of the bicycle than behind the bicycle.

15. The bicycle of claim 13, wherein the buzzer is controlled by a horn button mounted on a handlebar or a brake lever assembly of the bicycle.

16. The bicycle of claim 1, wherein the main processor is coupled to at least one of: a radio frequency (RF) transceiver, an accelerometer, a temperature sensor, an ambient light sensor.

17. A bicycle comprising:
a stem having a proximal portion and a distal portion, the proximal portion is coupled to a steer tube of the bicycle, the proximal portion is coupled to a handlebar of the bicycle;
a display is coupled to an upper surface of the distal portion of the stem;
a graphics processor running software that is coupled to the display and the stem wherein a user interface controls information that is displayed on the display;
a main processor coupled to the graphics processor;
a battery providing electrical power to the graphics processor and the display;
a global positioning system (GPS) coupled to the main processor for providing location information;
a memory coupled to the main processor for storing the software; and
a joystick that communicates with the user interface.

18. The bicycle of claim 17, further comprising:
a dynamo hub connected to a wheel of the bicycle and the battery, wherein the dynamo hub charges the battery.

19. The bicycle of claim 17, further comprising:
a fork coupled to a front wheel of the bicycle and the steer tube; and
a lighting system integrated into the fork.

20. The bicycle of claim 19, wherein the lighting system includes:
a right light emitting diode (LED) coupled to the battery and integrated into a right leg of the fork; and
a left LED coupled to the battery and integrated into a left leg of the fork.

21. The bicycle of claim 20, wherein the lighting system includes a right heat sink coupled to the right LED and the right left of the fork and a left heat sink coupled to the left LED and the left of the fork.

22. The bicycle of claim 20, wherein the right LED and the left LED are between 100 mm and 500 mm from a distal end of the fork.

23. The bicycle of claim 17, further comprising:
a buzzer coupled to a head tube of the bicycle, wherein the buzzer is powered by the battery.

24. The bicycle of claim 23, wherein the buzzer is actuated by a horn button mounted on a handlebar or a brake lever assembly of the bicycle.

25. The bicycle of claim 17, wherein the joystick is mounted on a handlebar or a brake lever assembly of the bicycle.

26. The bicycle of claim 17, wherein the main processor is coupled to at least one of: a radio frequency (RF) transceiver, an accelerometer, a temperature sensor, an ambient light sensor.
